(19) United States
(12) Patent Application Publication
(10) Pub. No.: US 2026/0051202 A1
(43) Pub. Date: Feb. 19, 2026

(54) METHOD FOR DETERMINING LOADING EVENT OF A VEHICLE AT A SITE

(71) Applicant: Volvo Truck Corporation, GÖTEBORG (SE)

(72) Inventor: Martin SYLVÉN, ASKIM (SE)

(21) Appl. No.: 19/260,013

(22) Filed: Jul. 3, 2025

(30) Foreign Application Priority Data
Aug. 13, 2024 (EP) 24194336.4

(51) Int. Cl. G07C 5/00; G07C 5/08

(52) U.S. Cl. CPC G07C 5/008; G07C 5/0816

(57) ABSTRACT

A computer system is disclosed. The computer system comprises processing circuitry configured to detect a change in weight of the vehicle when the vehicle is stationary or moving at a reduced speed, as a response to detecting the change in weight, determine vehicle data of the vehicle, wherein the vehicle data at least comprises positioning data and time data. The processing circuitry is configured to determine a loading event or an off-loading event of the vehicle, wherein the determination at least is based on the detected change in weight of the vehicle; and determine loading event information, wherein the loading event information at least comprises the vehicle data and the loading event or off-loading event.

### CROSS REFERENCE TO RELATED APPLICATION

This application claims foreign priority to European Application 24194336.4 filed on Aug. 13, 2024, the disclosure and content of which is incorporated by reference herein in its entirety.

### TECHNICAL FIELD

The disclosure relates generally to vehicles. In particular aspects, the disclosure relates to a method for determining loading event of a vehicle at a site. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Vehicles are often used to transport different kinds of goods. The process of loading and off-loading vehicles at various sites is a critical operation in many industries, including logistics, manufacturing, construction, and retail. This process involves the transfer of goods, materials, or equipment from one location to another, ensuring the efficient and safe handling of items. The loading and off-loading may be performed at a site, being a loading and/or off-loading site. The site may be manually operated, or partly or fully mechanical or automated. The site is normally equipped with a stationary scale with the purpose of determining the weight of the goods being transported. The weight of the goods is then used to determine an appropriate fee for the loading/off-loading.

There is a need to increase the efficiency of weighing goods at a site.

### SUMMARY

According to a first aspect of the disclosure, a computer system comprising processing circuitry configured to: detect a change in weight of the vehicle when the vehicle is stationary or moving at a reduced speed, obtain vehicle data of the vehicle, wherein the vehicle data at least comprises positioning data and time data; determine a loading event or an off-loading event of the vehicle, wherein the determination at least is based on the detected change in weight of the vehicle; and determine loading event information, wherein the loading event information at least comprises the vehicle data and the determined loading event or off-loading event. The first aspect of the disclosure may seek to provide an efficient way of eliminating the need of physical scales at loading/off-loading sites. A technical benefit may include that the vehicle itself can determine if a loading or off-loading event has taken place, without the need of a physical scale at the site. A technical benefit may include that the site is cheaper to maintain, thus keeping the prices down for the goods that are stored therein. Another technical benefit may include that it is possible to differentiate the weight of the goods being transported by each vehicle, which thus allows for an efficient way of determining the price that should be paid by the transporter for the goods.

Optionally, in some examples, a computer system comprising processing circuitry configured to detect a change in weight of the vehicle when the vehicle is stationary or moving at a reduced speed, obtain vehicle data of the vehicle, determine a loading event or an off-loading event of the vehicle; and transmit at least the loading event or off-loading event to an external unit, wherein said external unit is configured to determine loading event information.

Optionally, in some examples, a computer system comprising processing circuitry configured to detect a change in weight of the vehicle when the vehicle is stationary or moving at a reduced speed, obtain vehicle data of the vehicle, transmit the detected change in weight and the vehicle data to an external unit, wherein said external unit is configured to determine a loading event or an off-loading event of the vehicle and determine loading event information.

Optionally, in some examples, the processing circuitry is further configured to determine loading event information by determining that the weight of the vehicle is stabilized; and determine a new total weight of the vehicle. A technical benefit may include providing a reliable weight estimation that could be used to determine if a loading or off-loading event has taken place.

Optionally, in some examples, the new total weight of the vehicle is determined using at least an on-board weight measurement system. A technical benefit may include providing a reliable weight estimation that could be used to determine if a loading or off-loading event has taken place.

Optionally, in some examples, the loading event information comprises site information, wherein the site information is identified at least based on the loading event or off-loading event and the vehicle data. A technical benefit may include that the loading event and the site can be associated, which provides important information to the driver or other stakeholders, such as the owner of the site or owner of the goods that are transported.

Optionally, in some examples, the loading event information is transmitted to an external unit, wherein said external unit is configured to determine site information.

Optionally, in some examples, the loading event information comprises driver information identifying the driver of the vehicle, wherein the driver information is determined at least based on the vehicle data. A technical benefit may include a simpler and more efficient way of processing the payment of the goods.

Optionally, in some examples, the loading event information is transmitted to an external unit, wherein said external unit is configured to determine driver information.

Optionally, in some examples, the loading event information further comprises billing information of the loading or off-loading event. A technical benefit may include a simpler and more efficient way of processing the payment of the goods.

Optionally, in some examples, the loading event information is transmitted to an external unit, wherein said external unit is configured to determine billing site information.

Optionally, in some examples, the vehicle data further comprises one or more of: energy consumption of the vehicle, ID-information of the driver, and an odometer value. A technical benefit may include a simpler and more efficient way of processing the payment of the goods.

Optionally, in some examples, wherein the processing circuitry is further configured to determine a transportation mission based on the loading and/or off-loading event, wherein the transportation mission comprises at least one of transported weight, transport time, transported distance and energy consumed during transport. A technical benefit may include beneficial information to the driver or different stakeholders.

According to a second aspect of the disclosure, vehicle comprising the computer system of the first aspect is provided.

According to a third aspect of the disclosure, a computer-implemented method, comprising detecting, by processing circuitry of a computer system, a change in weight of the vehicle when the vehicle is stationary or moving at a reduced speed, obtaining, by the processing circuitry, vehicle data of the vehicle, wherein the vehicle data at least comprises positioning data and time data, determining, by the processing circuitry, a loading event or an off-loading event of the vehicle, wherein the determination is made based on the detected change in weight of the vehicle; and determining, by the processing circuitry, loading event information, wherein the loading event information at least comprises the vehicle data and the determined loading event or off-loading event.

Optionally, in some examples, further comprising determining driver information identifying the driver of the vehicle at least based on positioning data of the vehicle data, and determining billing details of the loading or off-loading event.

According to a fourth aspect of the disclosure, a computer program product comprising program code for performing, when executed by the processing circuitry cause the processing circuitry to perform the third aspect of the disclosure.

According to a fifth aspect of the disclosure, a non-transitory computer-readable storage medium comprising instructions, which when executed by the processing circuitry, cause the processing circuitry to perform the third aspect of the disclosure.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary view of a vehicle according to an example.

FIG. 2 is a schematic view of a system according to an example.

FIGS. 3A-B are exemplary system diagrams of functionality of a computer system (FIG. 3A) and a computer system (FIG. 3B).

FIGS. 4A-B are flow charts of exemplary methods according to examples.

FIG. 5 is a flow chart of an exemplary method according to an example.

FIGS. 6A-C are flow charts of exemplary methods according to examples.

FIG. 7 is another view of FIG. 3B, according to an example.

FIG. 8 is a flow chart of an exemplary method according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

As indicated in the above background section, the process around loading and off-loading a vehicle at a site can be made more efficient. More specifically, the service for identifying the load and off-loading sites as well as creating correct billing information is targeted. In prior art systems, the loading sites needs to be equipped with physical scales in order to determine the correct payment of the loading/off-loading event. This is both time consuming for the drivers of the vehicle, as well as expensive for the site owners. The present disclosure provides an insightful approach where the need for physical scales at the loading sites are eliminated. As will soon be described in detail, the system allows the vehicle to determine the change in weight. This information together with position data of the vehicle together identifies both the site and the loaded/off-loaded amount. By identifying the site, it is also possible to at least indirectly identify the driver/customer.

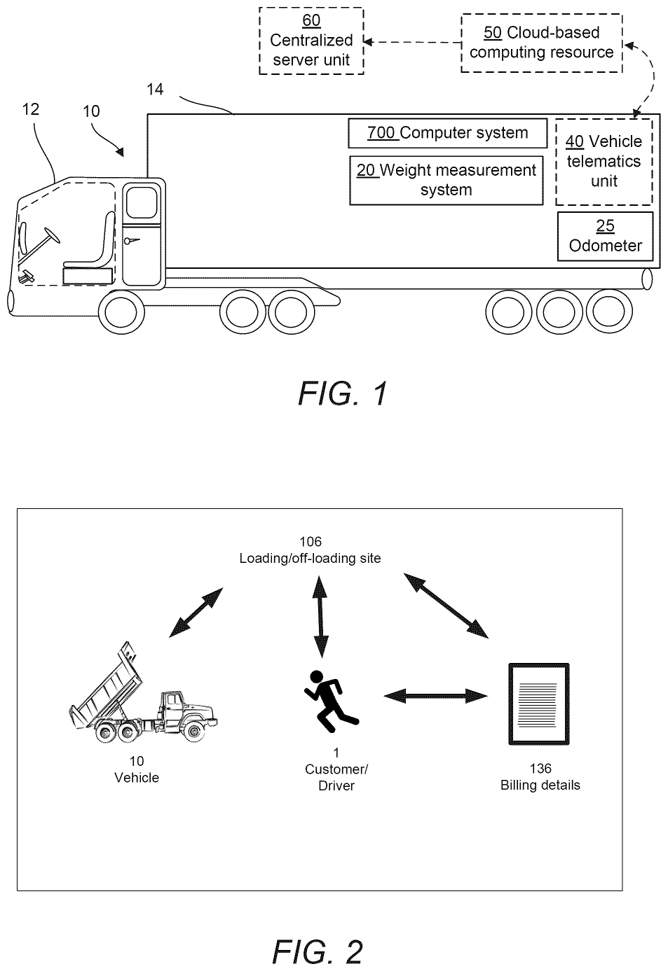

FIG. 1 is an exemplary schematic illustration of a heavy-duty vehicle 10 (hereinafter referred to as vehicle 10 for reasons of brevity). This particular example comprises a tractor unit 12 which is arranged to tow a trailer unit 14. The vehicle combination may of course also comprise additional vehicle units, such as one or more dolly units and more than one trailer unit. Although the vehicle is illustrated as a tractor unit, it should be realized that other types of vehicles may be equally considered for the purpose of the herein described method such as buses, construction equipment, trucks, etc. As a non-limiting example, the vehicle 10 may be a dump truck, transfer dump truck, tipper truck, side dump truck, roll-off truck, live bottom trailer, or haul trucks. Although not explicitly visualized in the figure, the skilled person will appreciate that the vehicle 10 comprises all necessary vehicle units and associated functionality such that it may operate as the skilled person would expect of a vehicle 10.

The vehicle 10 is supported by wheels 19, where each wheel comprises a tire 18. The tractor unit 12 has front wheels which are normally steered, and rear wheels of which at least one pair are driven wheels. Generally, the rear wheels of the tractor 12 may be mounted on tag or pusher axles. A tag axle is where the rear-most drive axle is non-powered, also referred to as a free-rolling or dead axle. A pusher axle is where the forward-most drive axle is not powered. The trailer unit 14 is supported on trailer wheels. Trailers with driven wheels, and even a steered axle, are also possible.

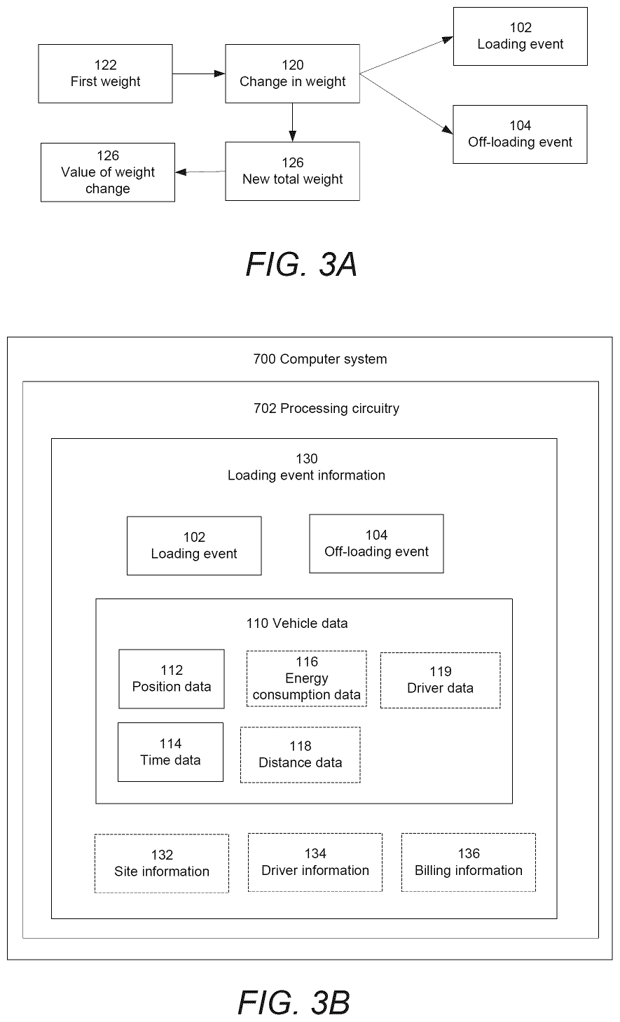

The vehicle 10 further comprises a computer system 700 comprising processing circuitry 702. The computer system 700 will be described in more detail with reference to FIGS. 3A-B. The computer system 700 may comprise a vehicle control unit (VCU) arranged to control various functions of the vehicle 10. For instance, the VCU may be arranged to perform a vehicle motion management (VMM) function comprising control of wheel slip, vehicle unit stability, and so on. The trailer unit optionally also comprises a VCU, which then controls one or more functions on the trailer. The VCU or VCUs may be communicatively coupled, e.g., via wireless link, to a remote server. This remote server may be arranged to perform various configurations of the ECU, and to provide various forms of data to the ECU, such as for example providing data regarding the make and type of tires mounted on the vehicle. The trailer unit 14 optionally also comprises one or more electronic control units (ECUs), which may be adapted to control one or more functionalities of the trailer unit 12.

The computer system may be communicatively coupled, e.g., via wireless link, to a remote server 60. This remote server may also be referred to as a centralized server unit 60.

The computer system 700 may be configured to obtain information from different kinds of sensors or services. For example, the vehicle may be in communication with a weather service and/or a navigation service. In one example, the computer system 700 is in communication with vehicle state sensors such as radar sensors, sensors based on LiDAR and/or vision based sensors such as camera sensors and infrared detectors.

The vehicle 10 advantageously comprises a vehicle telematics unit 40. The vehicle telematics unit 40 is configured for obtaining data from the vehicle 10, such as from the computer system 700 or weight measurement system 20, and communicate said data wirelessly to an external service. The results may be transmitted by the vehicle telematics unit 40 to a cloud-based computing resource 50 during an ongoing operation of the vehicle 10, i.e., in online mode. Alternatively, or additionally, control signal responses may be sent as raw data to the cloud-based computing resource 50, and subsequent obtaining, comparing and determining information may be performed by the cloud-based computing resource 50. To this end, the determination steps may be carried out remote from the vehicle 10. The operation of the vehicle 10 may be a particular usage of the vehicle 10, such as a start-up at a first location, a drive to a second location, and a shutdown at said second location. Such online data transmission may be realized in at least near real-time, where at least near real-time is to be interpreted as involving some minor delay caused by, for instance, network connectivity, latencies, or other similar reasons. In some examples, batch processing and transfer of the data may be realized. In this particular example, the vehicle telematics unit 40 is configured to be in communication with a cloud-based computing resource 50. The communication may be based on any known short-range or long-range standards or protocols known in the art. The following list of examples are some exemplary network/radio communication standards or protocols that may be employed by the vehicle telematics unit 40 and the cloud-based computing resource 50: HTTP(S), TCP/IP, UDP, FTP, SMTP, DNS, DHCP, SSH, POP3, SCP, NFS, SFTP, ICMP, ARP, RTP, RTCP IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any form of proximity-based device-to-device radio communication, LTE Direct, W-CDMA/HSPA, GSM, UTRAN, LTE, IPv4, IPv6, 6LoWPAN, IrDA, or 5G NR.

The cloud-based computing resource 50 may be implemented using any commonly known cloud-computing platform technologies, such as e.g. Amazon Web Services, Google Cloud Platform, Microsoft Azure, DigitalOcean, Oracle Cloud Infrastructure, IBM Bluemix or Alibaba Cloud. The cloud-based computing resource 50 may be included in a distributed cloud network that is widely and publicly available, or alternatively limited to an enterprise. The cloud-based computing resource 50 may comprise a cloud-based storage unit. The cloud-based storage unit may be included with or external to the cloud-based computing resource 50. Connection to the cloud-based storage unit may be established using DBaaS (Database-as-a-service). For instance, the cloud-based storage unit may be deployed as a SQL data model such as MySQL, PostgreSQL or Oracle RDBMS. Alternatively, deployments based on NoSQL data models such as MongoDB, Amazon DynamoDB, Hadoop or Apache Cassandra may be used. DBaaS technologies are typically included as a service in the associated cloud-based computing resource 50.

The cloud-based computing resource 50 may be in further communication with a centralized server unit 60. Communication between the cloud-based computing resource 50 and the centralized server unit 60 may be realized by any of the communication standards or protocols as mentioned above with respect to the cloud-based computing resource 50 and the vehicle telematics unit 40. The centralized server unit 60 may be configured for collecting and analyzing data from a plurality of vehicles, and subsequently provide new and/or updated data to said plurality of vehicles based on various factors such as new contactor device types or characteristics.

In some examples, the determinations processes are not necessarily transferred from the vehicle telematics unit 40 to the centralized server unit 60 during an ongoing operation of the vehicle 10. Instead, the determinations processes may be transferred in an offline fashion after the vehicle 10 has finished an operation. Hence, the vehicle telematics unit 40 is configured to store the identification results during the operation, but the transfer is not effected until after said operation is completed. This may be realized in certain situations, such as at vehicle workshops or other vehicle maintenance locations.

The vehicle 10 further comprises an on-board weight measurement system 20. The on-board weight measurement system is configured to measure and/or estimate the weight of the vehicle 10. The on-board weight measurement system may use different technology, for example using load cell technology or pressure readings from air suspension to calculate the weight on the vehicle axles. The on-board weight measurement system 20 may in one example comprise load-cell scales, air-suspension PSI gauges, air-suspension load scales and/or electronic scales with PSI sensors.

The vehicle 10 may further comprise an odometer 25. The odometer 25 may be electronic, mechanical or electromechanical. The odometer 25 may be a trip odometer (trip meter).

The vehicle 10 can be arranged with a load. The load may for example be arranged in a container or trailer arranged in or on the vehicle 10. The load may be any kind of load that has a weight. One example is bulk load, such as commodities. As a non-limiting example, the load may be coal, petroleum, grains, ores, chemicals, liquids or gas. The load may also be gravel, construction aggregate, potatoes, top soil, grain, carrots, sand, lime, peat moss, asphalt, compost, rip-rap, heavy rocks, biowaste, etc.

FIG. 2 is a schematic illustration of a vehicle 10 being arranged at a site 106. The site 106 may be a loading/off-loading site. In one example, the site may be a loading site 106 where the vehicle 10 is being loaded with a load. The site 106 is then arranged with a storage of the load which is then being loaded onto the vehicle 10. In one example, the site is an off-loading site 106 where the vehicle 10 is being off-loaded. The site 106 is then arranged to receive a load of a vehicle 10. In one example, the site 106 is both a loading and off-loading site. Herein, the term loading/off-loading site 106 will cover all these examples. In one example, the site 106 comprises one or more loading docks or loading ramp.

A loading or off-loading event is typically associated with a cost for the driver 1 of the vehicle. The driver 1 of the vehicle 10 may thus also be referred to as the customer at the loading/off-loading site. The cost of the loading/off-loading event is at least in part based on the weight of the cargo being loaded or un-loaded at the site. The cost of the loading/off-loading event may further include accessorial charges. Accessorial charges may for example relate to special handling or equipment at the loading site. In one example the cost of the loading/off-loading event includes the cost of using a liftgate, pallet jacks or forklifts at the site. In one example, the cost of the loading/off-loading event includes costs of using additional time for performing the loading/off-loading event compared to the allocated time.

In prior art systems, the sites typically have a stationary scale. The prior art systems are often not able to bill two customers that are off-loading or loading at the same time, as the system can not differentiate the weight of each vehicle—it can just determine the total weight.

The billing details 136 of the load/off-loading event are correlated to the customer/driver 1. This correlation may be based on different parameters, as will soon be described. The billing details 136 preferably comprises information relating to the cost of the loading/off-loading event. The billing details are associated with information relating to the identified customer. If the system identifies that there are customers associated to a position where a loading/off-loading event takes place, the system can automatically create the billing information. If the system cannot identify that there are customers in the associated position, an operator may create a customer for that specific position or export the generated data to manually create an invoice.

FIGS. 3A-B are schematic illustrations of functions of a computer system 700 according to examples. In one example, the computer system 700 is configured to obtain or determine a first weight 122 of the vehicle. The first weight 122 of the vehicle is the weight before a loading or off-loading event has occurred. The first weight 122 of the vehicle can also be referred to as an initial weight. The computer system 700 is configured to detect a change in weight 120 of the vehicle 10. The detected change in weight 120 is used to determine a loading event 102 or an off-loading event 104. In one example, the computer system 700 is further configured to determine a new total weight 126 of the vehicle. In one example, the computer system 700 is further configured to determine the value 126 of the change in weight based on the new total weight of the vehicle 10. The weight may for example be measured in kilos, tons or pounds.

As is illustrated in FIG. 3B, the computer system 700 is further configured to determine loading event information 130. The loading event information 130 at least comprises vehicle data 100 and the loading event 102 and/or off-loading event 104.

The computer system 700 comprising processing circuitry 702 is configured to obtain vehicle data 110. The vehicle data 110 at least includes positioning data 112. The positioning data 112 pertains to the position of the vehicle 10. The positioning data may comprise specific coordinates or an area of coordinates. The positioning data 112 may be obtained from a positioning system 30. The positioning system may for example comprise a global positioning system (GPS).

The vehicle data 110 further includes time data 114. The time data 114 pertains to time information. The time information 114 may be a time interval or specific time stamps. In one example the time information is given in small increments, such as minutes. In one example, the time data 114 may relate to the time of the day, such as a specific time or time range (morning, midday/noon, afternoon, evening, night). The information relating to the time may be received from a remote server, such as the remote server as defined with reference to FIG. 1, being in communication with the vehicle or from on-board server of the vehicle.

In one example, the vehicle data 110 further includes distance data 118. Distance data 118 may pertain to the distance traveled by the vehicle. The distance data 118 may be obtained from an odometer 25 arranged in the vehicle 10.

In one example, the vehicle data 110 further includes energy consumption data 116. The energy consumption data 116 pertains to a value of how much energy the vehicle is consuming.

In one example, the vehicle data 110 further includes information pertaining to the one or more drivers 1 of the vehicle 10. The information may be ID-information of the driver 1.

The loading event information 130 may further comprise site information 132, driver information 134 and/or billing information 136. The site information 132 may comprise an identification of a site 106. The identification may be based on associating the loading event 102 or off-loading event 104 of the vehicle 10 with the position data 112 of the vehicle data 110. In other words, the loading/un-loading site 106 may be identified by connecting the position data 112 with the loading/off-loading event 102, 104.

Driver information 134 may comprise information identifying the driver 1 of the vehicle 10. The driver information 134 is preferably based on vehicle data 110. In one example, the driver information 134 is based on driver data 119 of the vehicle data 110.

Billing information 136 may comprise billing information of the loading event 102 and/or the off-loading event 104.

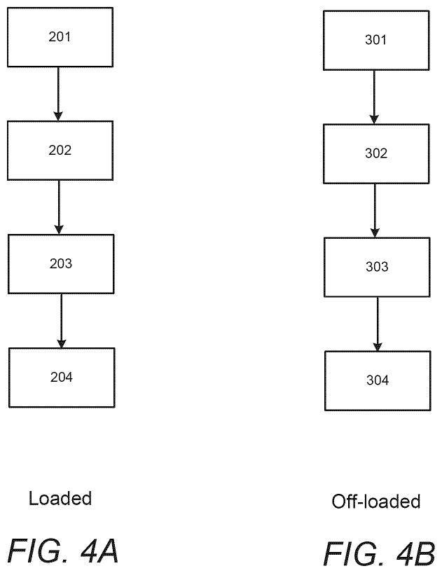

FIGS. 4A-B are flow charts of examples of methods to load (FIG. 4A) and off-load (FIG. 4B) a vehicle at a site 106. Turning to FIG. 4A, an unloaded vehicle is arriving 201 at a loading site. An unloaded vehicle may also be referred to as a vehicle having no external load, an empty vehicle, or a vehicle without any cargo.

The vehicle that is about to get loaded with cargo reduces the driving speed upon reaching a targeted loading area in the loading site. In one example, the vehicle 10 is put in a stationary or parked position 202 before initiating the loading of the cargo onto the vehicle 10. In an alternative example, the vehicle 10 is moving at a reduced speed 202 once the cargo is loaded onto the vehicle 10. The reduced speed is preferably very slow, such as for example 5-10 km/h.

The vehicle 10 is then loaded 203 with cargo arranged at the loading site 106. The vehicle 10 may be fully loaded, or only partly loaded. Once the vehicle 10 is loaded with its cargo, the vehicle departs 204 from the loading site 106. If the vehicle 10 was loaded from a stand still position, departing from the loading site includes increasing the speed from zero to a suitable driving speed. If the vehicle 10 was loaded while having a reduced speed, not being stand-still, departing from the loading site includes increasing the speed from the reduced speed to a suitable driving speed.

Turning to FIG. 4B, a loaded vehicle is arriving 301 at a loading site. The vehicle is driving at a reduced speed 302, or is in a stationary or parked position 302 before it is getting off-loaded with cargo arranged at the loading site 106. In one example, the vehicle is driving at a reduced speed 302 when unloading the cargo. This may for example be the case when a vehicle is driven in reverse to off-load the cargo from the vehicle.

The vehicle 10 is then off-loaded, i.e. the cargo, or parts of the cargo, of the vehicle is off-loaded onto the loading site 106. The vehicle 10 may be fully emptied, or only partly emptied. Once the vehicle 10 is off-loaded with at least some of its cargo, the vehicle departs 304 from the loading site 106. If the vehicle 10 was off-loaded from a stand still position, departing from the loading site includes increasing the speed from zero to a suitable driving speed. If the vehicle 10 was off-loaded while having a reduced speed, not being stand-still, departing from the loading site includes increasing the speed from the reduced speed to a suitable driving speed.

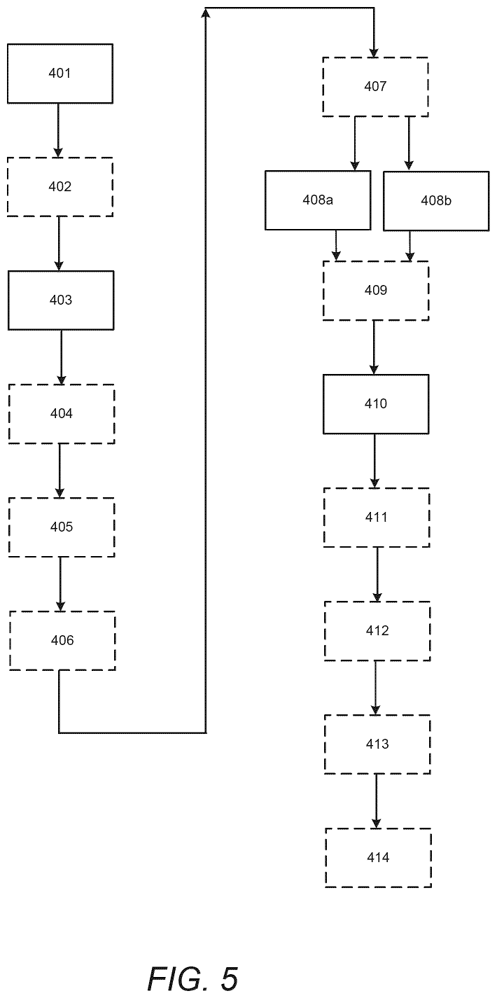

FIG. 5 is an illustrative flow chart of an example of a method during a loading event and an off-loading event.

In one example, the computer system 700 of the vehicle 10 detects 401 a change in weight of the vehicle. In one example, the method further comprises identifying 402 that the detected change in weight is above a predetermined threshold. The threshold may be defined in any size depending on for example the intended cargo. As an example, the threshold may be 1000 kg. In one example, computer system 700 saves the change in weight as a preliminary weight change. In one example, the new weight of the vehicle 10 is not yet determined.

The method further comprises obtaining 403 vehicle data 110 of the vehicle 10, this is preferably performed by the computer system 700. The vehicle data 110 may be obtained from the vehicle 10. In one example, the vehicle data 110 is obtained when a detected change in weight is determined. In one example, the vehicle data 110 is obtained when the detected change in weight is above a predetermined threshold. In one example, the vehicle data 110 is obtained continuously. In one example, the vehicle data 110 is obtained as a response to detecting the change in weight.

Once the vehicle data 110 is obtained, the vehicle data 110 is saved. The vehicle data 110 may be saved in a memory of the computer system 700. In one example, the vehicle data 110 is saved when the detected change in weight is above a predetermined threshold. In one example, the vehicle data 110 is saved upon being obtained.

In one example, the method further comprises determining 404 that the weight of the vehicle 10 is stabilized. The weight of the vehicle 10 is stabilized once the load/off-loading event is completed. The computer system 700 may be configured to determine that the weight of the vehicle is stabilized when no weight difference is detected for a predetermined time frame. The computer system 700 may be configured to determine that the weight of the vehicle is stabilized when the weight difference detected is the same for a predetermined time frame. The computer system 700 may be configured to determine that the weight of the vehicle is stabilized when the new total weight of the vehicle 10 is established within a predetermined range.

In one example, the method comprises determining 405 the new weight of the vehicle 10. In one example, this is performed by the computer system 700 of the vehicle. In one example, the computer system 700 determines the new weight of the vehicle 10 once it is determined that the weight of the vehicle is stabilized.

The determination of the new weight may be based on the on-board weight measurement system 20. In one example, the on-board weight measurement system 20 determines the weight while the vehicle 10 is stationary or driving at a reduced speed at the loading site 106. In one example, the on-board weight measurement system 20 determines the weight while the vehicle 10 is moving, or driving at an increased speed. In yet one example, the on-board weight measurement system 20 estimates a preliminary weight while the vehicle 10 is stationary and determines the weight once the vehicle is moving. As should be understood, other combinations are possible.

In some examples, the on-board weight measurement system 20 uses input from the engine and the gearbox while the vehicle 10 is moving in order to determine the new weight.

The determined weight information is preferably saved. By establishing the new weight of the vehicle 10, it is also possible to determine the exact detected weight change.

In one example, the method further comprises determining 406 the value of the change in weight. In one example, the value of the change in weight is based on the new total weight of the vehicle 10.

The method may further comprise determining 407 if the change in weight was due to a loading event 102 or an off-loading event 104. The determination 407 is based on the detected change in weight of the vehicle, the new total weight of the vehicle or a combination of both. In one example, this is performed by the computer system 700.

If it is detected that the change of weight is a decrease in total weight of the vehicle, the system determines 408a that an off-loading event 104 has taken place. If the system has detected that the change of weight is an increase in total weight of the vehicle, the system determines 408b that a loading event 102 has taken place.

In one example, method further comprises determining loading event information 130 by determine 409 the value of the change in weight. The value of the change in weight may preferably be determined based on the new total weight of the vehicle 10. The determination 409 may also be seen as associating 409 the loading event 102 or off-loading event 104 of the vehicle 10 with the value of the change in weight. In one example, this is performed by the computer system 700.

The method further comprises determining 410 loading event information 130. The loading event information 130 at least comprises the vehicle data 110 and the loading event 102 or off-loading event 104. The determination may also be seen as associating 410 the loading/off-loading event with the vehicle data 110. As the vehicle data 110 comprises information relating to the position of the vehicle, as well as the time, it is possible to connect the vehicle 10, and thus its driver, with the loading/off-loading event and the loading site 106. In one example, this is performed by the computer system 700.

The method may further comprise identifying 411 the loading/un-loading site 106. The loading event information 130 may comprise site information 132. The identification may be based on the loading event 102 or off-loading event 104 and the vehicle data 110. The identification 411 may further be based on associating the loading event 102 or off-loading event 104 of the vehicle 10 with the position data 112 of the vehicle data 110. In other words, the loading/un-loading site 106 may be identified by connecting the position data 112 with the loading/off-loading event 102, 104. In one example, this is performed by the computer system 700.

The method may further comprise determining 412 loading event information comprising driver information 134. The method may comprise identifying 412 the driver of the vehicle 10. The identification of the driver information may be based at least based on the vehicle data 110. The identification of the driver may also be seen as connecting 412 the loading or off-loading event 102, 104 of the vehicle 10 with a driver being associated with the positioning data 112. In one example, this is performed by the computer system 700.

The method may further comprise determining loading event information 130 by determining 413 billing information 136 of the loading or off-loading event 102, 104. The determination of the billing information 136 may further be seen as associating 413 the driver 1 with billing details 108 of the loading or off-loading event 102, 104. In one example, this is performed by the computer system 700.

The method may further comprise associating 414 the loading event 102 or off-loading event 104 to a transportation mission. In other words, the method comprises determining 414 a transportation mission at least based on the loading event 102 or off-loading event 104. The transportation mission comprises at least one of: transported weight, transport time, transported distance and energy consumed during the transport.

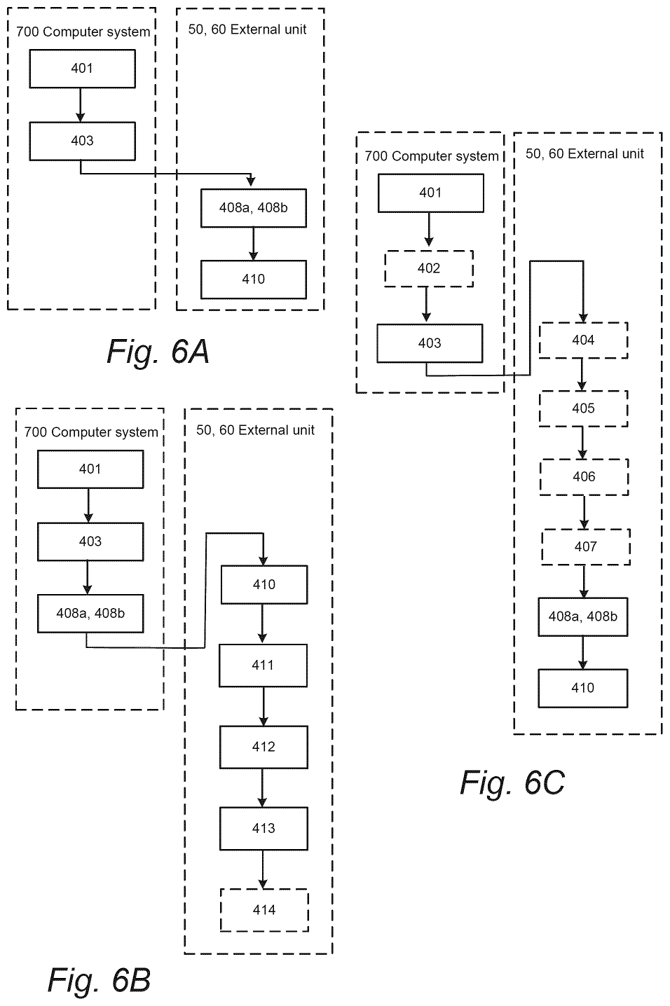

In one example, the computer system 700 is configured to perform all steps. However, as have already been described, some or all of the steps may be performed external to the computer system 700 and/or external to the vehicle. Different examples of methods are disclosed in FIGS. 6A-C.

In one example, as for example shown in FIG. 6A, the vehicle data is transmitted to an external unit such as a centralized server unit 60 or to a cloud-based computing resource 50. The centralized server unit 60 or the cloud-based computing resource 50 is then configured to determine 408 a loading event 102 or an off-loading event 104. The centralized server unit 60 or the cloud-based computing resource 50 may further be configured to determine 410 loading event information 130. Hence, at least steps 408 and 410 may be performed by another entity than the computer system 700. If present, the steps 411, 412, 413, 414 may be performed by the centralized server unit 60 or the cloud-based computing resource 50. As should be understood, a mixture of determination steps is possible where the computer system 700 performs some steps and the centralized server unit 60 or the cloud-based computing resource 50 performs other.

In one example, a computer system comprising processing circuitry 702 configured to detect a change in weight 120 of the vehicle 10 when the vehicle is stationary or moving at a reduced speed, obtain vehicle data 110 of the vehicle 10, wherein the vehicle data 110 at least comprises positioning data 112 and time data 114, transmit the detected change in weight and the vehicle data 110 to an external unit 50, 60. The external unit is configured to determine a loading event 102 or an off-loading event 104 of the vehicle 10, wherein the determination at least is based on the detected change in weight of the vehicle 10; and transmit the loading event or off-loading event 102, 104 and the vehicle data 110 to an external unit 50, 60, wherein said external unit 50, 60 is configured to determine loading event information 130 at least based on vehicle data 110 and the determined loading event 102 or off-loading event 104.

In one example, an external unit (such as a cloud-based computing resource 50 or a centralized server unit 60) is configured to: receive a detected change in weight and vehicle data, determine a loading event 102 or an off-loading event 104, and determine loading event information 130 at least based on vehicle data 110 and the determined loading event 102 or off-loading event 104. In some examples, the external unit is further configured to determine site information 132, determine driver information 134 and/or determine billing information 136.

As illustrated in the example of FIG. 6B, the determination of a loading event 102 or an off-loading event 104 may be performed by the computer system 700. In this example, the loading event 102, 104 is then transmitted to the external unit 50, 60. The external unit 50, 60 may then be configured to determine 410 loading event information 130. In this example, the external unit 50, 60 is further configured to identifying 411 the loading/un-loading site 106, determining 412 driver information 134, determining 413 billing information 136 of the loading or off-loading event 102, 104 and possibly also determining 414 a transportation mission at least based on the loading event 102 or off-loading event 104.

In one example, a computer system comprising processing circuitry 702 configured to detect a change in weight 120 of the vehicle 10 when the vehicle is stationary or moving at a reduced speed, obtain vehicle data 110 of the vehicle 10, wherein the vehicle data 110 at least comprises positioning data 112 and time data 114, determine a loading event 102 or an off-loading event 104 of the vehicle 10, wherein the determination at least is based on the detected change in weight of the vehicle 10; and transmit the loading event or off-loading event 102, 104 and the vehicle data 110 to an external unit 50, 60, wherein said external unit 50, 60 is configured to determine loading event information 130 at least based on vehicle data 110 and the determined loading event 102 or off-loading event 104.

In one example, the external unit 50, 60 may be configured determine site information 132, wherein the site information 132 is determined at least based on the loading event 102 or off-loading event 104 and the vehicle data 110.

In one example, the external unit 50, 60 may be configured to determine driver information 134 identifying the driver 1 of the vehicle 10, wherein the driver information 134 is determined at least based on the vehicle data 110.

In one example, the external unit 50, 60 may be configured to determine billing information 136 of the loading or off-loading event 102, 104.

In one example, the external unit 50,60 is an cloud-based computing resource 50 or a centralized server unit 60.

In one example, an external unit (such as a cloud-based computing resource 50 or a centralized server unit 60) is configured to: receive a loading event 102 or an off-loading event 104, determine loading event information 130 at least based on vehicle data 110 and the determined loading event 102 or off-loading event 104. In some examples, the external unit is further configured to determine site information 132, determine driver information 134 and/or determine billing information 136.

FIG. 6C shows yet one example of a method. In this example, most of the determination steps are performed by the external unit 50, 60. The external unit 50,60 may for example be configured to determine 404 that the weight of the vehicle 10 is stabilized, determine 405 the new weight of the vehicle 10, determine 406 the value of the change in weight and determine 407 if the change in weight was due to a loading event 102 or an off-loading event 104.

In one example, a computer system comprising processing circuitry 702 is configured to: detect a change in weight 120 of the vehicle 10 when the vehicle is stationary or moving at a reduced speed, obtain vehicle data 110 of the vehicle 10, wherein the vehicle data 110 at least comprises positioning data 112 and time data 114, transmit vehicle data 110 to a centralized server unit 60, wherein the centralized server unit 60 is configured to determine a loading event 102 or an off-loading event 104 of the vehicle 10, wherein the determination at least is based on the detected change in weight of the vehicle 10, and determine loading event information 130, wherein the loading event information 130 at least comprises the vehicle data 110 and the loading event 102 or off-loading event 104. In one example, the centralized server unit 60 is further configured to determine the site information 132, identifying the driver and/or determine billing information 136.

In one example, a computer system comprising processing circuitry 702 is configured to: detect a change in weight 120 of the vehicle 10 when the vehicle is stationary or moving at a reduced speed, obtain vehicle data 110 of the vehicle 10, wherein the vehicle data 110 at least comprises positioning data 112 and time data 114, transmit vehicle data 110 to a cloud-based computing resource 50, wherein the cloud-based computing resource 50 is configured to determine a loading event 102 or an off-loading event 104 of the vehicle 10, wherein the determination at least is based on the detected change in weight of the vehicle 10, and determine loading event information 130, wherein the loading event information 130 at least comprises the vehicle data 110 and the loading event 102 or off-loading event 104. In one example, the cloud-based computing resource 50 is further configured to determine the site information 132, identifying the driver and/or determine billing information 136.

In one example, a computer system comprising processing circuitry configured to: transmit weight data to an external unit, wherein the external unit is configured to detect a change in weight of the vehicle when the vehicle is stationary or moving at a reduced speed based on said received weight data, transmit vehicle data of the vehicle to the external unit, wherein the vehicle data at least comprises positioning data and time data; and wherein the external unit is configured to: determine a loading event or an off-loading event of the vehicle, wherein the determination at least is based on the detected change in weight of the vehicle; and determine loading event information wherein the loading event information at least comprises the vehicle data and the determined loading event or off-loading event.

In one example, an external unit 50, 60 is configured to: receive weight data, detect a change in weight of the vehicle 10 when the vehicle is stationary or moving at a reduced speed based on said received weight data, receive vehicle data 110, determine a loading event 102 or an off-loading event 104, and determine loading event information 130 at least based on vehicle data 110 and the determined loading event 102 or off-loading event 104. In some examples, the external unit is further configured to determine site information 132, determine driver information 134 and/or determine billing information 136.

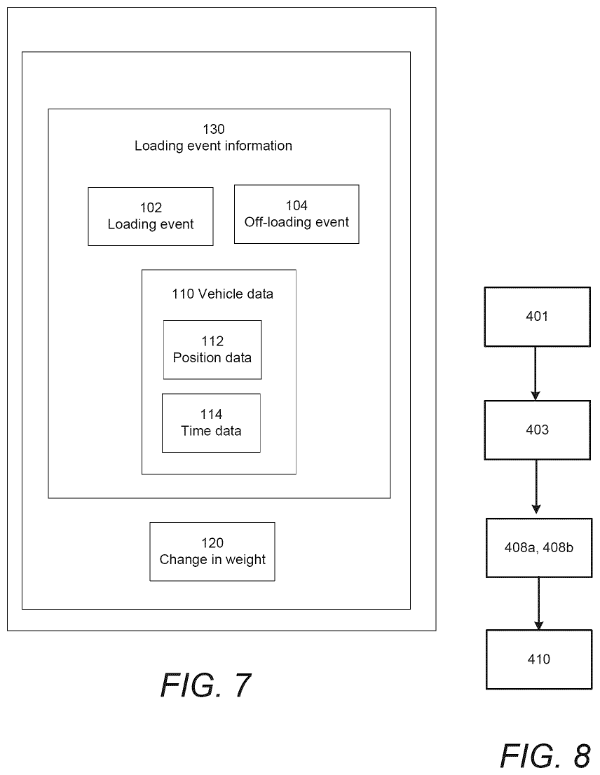

FIG. 7 is another view of FIG. 3B according to an example. A computer system comprising processing circuitry 702 configured to: detect a change in weight 120 of the vehicle 10 when the vehicle is stationary or moving at a reduced speed, obtain vehicle data 110 of the vehicle 10, wherein the vehicle data 110 at least comprises positioning data 112 and time data 114, determine a loading event 102 or an off-loading event 104 of the vehicle 10, wherein the determination at least is based on the detected change in weight of the vehicle 10, and determine loading event information 130, wherein the loading event information 130 at least comprises the vehicle data 110 and the loading event 102 or off-loading event 104.

FIG. 8 is a flow chart of a method to determine a loading event or off-loading event according to an example. A computer-implemented method is provided. The method comprises detecting 401, by processing circuitry of a computer system, a change in weight 120 of the vehicle 10 when the vehicle is stationary or moving at a reduced speed, obtaining 403, by the processing circuitry, vehicle data 110 of the vehicle 10, wherein the vehicle data 110 at least comprises positioning data 112 and time data 114. The method further comprises determining, by the processing circuitry, a loading event 102 or an off-loading event 104 of the vehicle 10, wherein the determination is made based on the detected change in weight of the vehicle; and determining 410, by the processing circuitry, loading event information 130, wherein the loading event information at least comprises the vehicle data 110 and the determined loading event 102 or off-loading event 104.

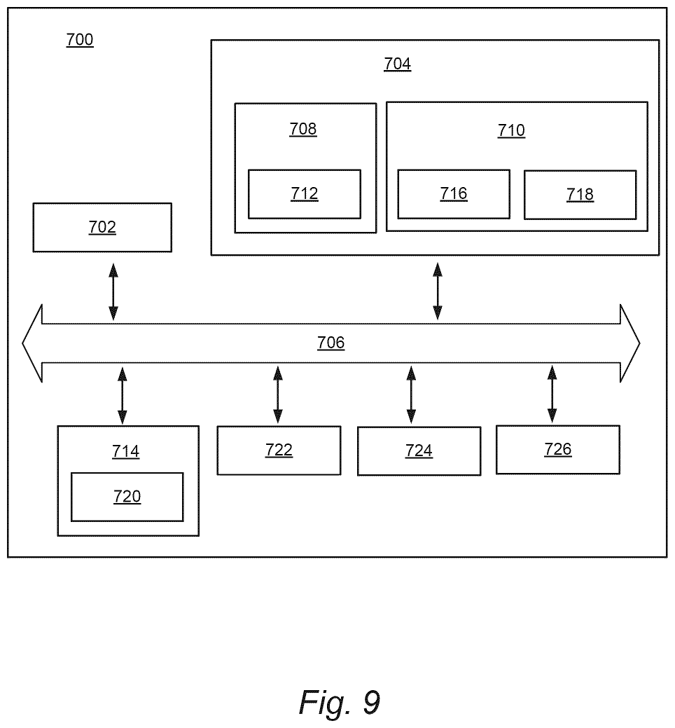

FIG. 9 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system comprising processing circuitry 702 configured to: detect a change in weight 120 of the vehicle 10 when the vehicle is stationary or moving at a reduced speed, obtain vehicle data 110 of the vehicle 10, wherein the vehicle data 110 at least comprises positioning data 112 and time data 114, determine a loading event 102 or an off-loading event 104 of the vehicle 10, wherein the determination at least is based on the detected change in weight of the vehicle 10, and determine loading event information 130, wherein the loading event information 130 at least comprises the vehicle data 110 and the loading event 102 or off-loading event 104.

Example 2: The computer system of example 1, wherein the processing circuitry is further configured to determine loading event information 130 by determine a new total weight 126 of the vehicle.

Example 3: The computer system of any of examples, wherein the processing circuitry is further configured to determine loading event information 130 by determine that the weight of the vehicle is stabilized, and determine a new total weight 126 of the vehicle.

Example 4: The computer system of example 2 or 3, wherein the processing circuitry is further configured to determine loading event information 130 by determine the value of the change in weight based on the new total weight of the vehicle 10.

Example 5: The computer system of any of examples 2-4, wherein the new total weight 126 of the vehicle 10 is determined using at least an on-board weight measurement system 20.

Example 6: The computer system of any of examples 1-5, wherein the loading event information 130 comprises site information 132, wherein the site information 132 is identified at least based on the loading event 102 or off-loading event 104 and the vehicle data 110.

Example 7: The computer system of any of examples 1-6, wherein the loading event information 130 comprises driver information 134 identifying the driver 1 of the vehicle 10, wherein the driver information 134 is determined at least based on the vehicle data 110.

Example 8: The computer system of example 7, wherein the loading event information 130 further comprises billing information 136 of the loading or off-loading event 102, 104.

Example 9: The computer system of any of examples 1-8, wherein the vehicle data 110 further comprises one or more of: energy consumption of the vehicle 116, ID-information of the driver, and an odometer value.

Example 10: The computer system of any of examples 1-9, wherein the processing circuitry is further configured to determine a transportation mission based on the loading and/or off-loading event 102, 104, wherein the transportation mission comprises at least one of transported weight, transport time, transported distance and energy consumed during transport.

Example 11: A vehicle comprising the computer system of any of examples 1-10.

Example 12: A computer-implemented method, comprising detecting 401, by processing circuitry of a computer system, a change in weight 120 of the vehicle 10 when the vehicle is stationary or moving at a reduced speed, obtaining 403, by the processing circuitry, vehicle data 110 of the vehicle 10, wherein the vehicle data 110 at least comprises positioning data 112 and time data 114, determining 408a, 408b, by the processing circuitry, a loading event 102 or an off-loading event 104 of the vehicle 10, wherein the determination is made based on the detected change in weight of the vehicle, and determining 410, by the processing circuitry, loading event information 130, wherein the loading event information 130 at least comprises vehicle data 110 and loading event 102 or off-loading event 104.

Example 13: The method of example 12, further comprising: determining 412 driver information 134 by identifying a driver 1 of the vehicle at least based on positioning data 112, and determining 413 billing details 108 of the loading or off-loading event 102, 104.

Example 14: A computer program product comprising program code for performing, when executed by the processing circuitry, the method of any of examples 12-13.

Example 15: A non-transitory computer-readable storage medium comprising instructions, which when executed by the processing circuitry, cause the processing circuitry to perform the method of any of examples 12-13.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
detect a change in weight of the vehicle when the vehicle is stationary or moving at a reduced speed,
obtain vehicle data of the vehicle, wherein the vehicle data at least comprises positioning data and time data;
determine a loading event or an off-loading event of the vehicle, wherein the determination at least is based on the detected change in weight of the vehicle; and
determine loading event information, wherein the loading event information at least comprises the vehicle data and the determined loading event or off-loading event.

2. The computer system of claim 1, wherein the processing circuitry is further configured to determine loading event information by:
determine a new total weight of the vehicle.

3. The computer system of claim 1, wherein the processing circuitry is further configured to determine loading event information by:
determine that the weight of the vehicle is stabilized; and
determine a new total weight of the vehicle.

4. The computer system of claim 2, wherein the processing circuitry is further configured to determine loading event information by:
determine the value of the change in weight based on the new total weight of the vehicle.

5. The computer system of claim 2, wherein the new total weight of the vehicle is determined using at least an on-board weight measurement system.

6. The computer system of claim 1, wherein the loading event information comprises site information, wherein the site information is identified at least based on the loading event or off-loading event and the vehicle data.

7. The computer system of claim 1, wherein the loading event information comprises driver information identifying the driver of the vehicle, wherein the driver information is determined at least based on the vehicle data.

8. The computer system of claim 7, wherein the loading event information further comprises billing information of the loading or off-loading event.

9. The computer system of claim 1, wherein the vehicle data further comprises one or more of: energy consumption of the vehicle, ID-information of the driver, and an odometer value.

10. The computer system of claim 1, wherein the processing circuitry is further configured to:
determine a transportation mission based on the loading and/or off-loading event, wherein the transportation mission comprises at least one of transported weight, transport time, transported distance and energy consumed during transport.

11. A vehicle comprising the computer system of claim 1.

12. A computer-implemented method, comprising:
detecting, by processing circuitry of a computer system, a change in weight of the vehicle when the vehicle is stationary or moving at a reduced speed,
obtaining, by the processing circuitry, vehicle data of the vehicle, wherein the vehicle data at least comprises positioning data and time data;
determining, by the processing circuitry, a loading event or an off-loading event of the vehicle, wherein the determination is made based on the detected change in weight of the vehicle; and
determining, by the processing circuitry, loading event information, wherein the loading event information at least comprises the vehicle data and the determined loading event or off-loading event.

13. The method of claim 12, further comprising:
determining driver information identifying the driver of the vehicle at least based on positioning data of the vehicle data, and
determining billing details of the loading or off-loading event.

14. A computer program product comprising program code for performing, when executed by the processing circuitry, the method of claim 12.

15. A non-transitory computer-readable storage medium comprising instructions, which when executed by the processing circuitry, cause the processing circuitry to perform the method of claim 12.
